(19) United States
(12) Patent Application Publication
(10) Pub. No.: US 2008/0109339 A1
(43) Pub. Date: May 8, 2008

(54) Systems and methods for creating hedges of arbitrary complexity using financial derivatives of constant risk

(76) Inventors: Lester Seigel, (US); Jerome lawrence Kreuser, (US)

Correspondence Address: Lester Seigel, 2765 South Ives Street, Arlington, VA, 22202, US

(21) Appl. No.: 11/977,504

(22) Filed: Oct. 24, 2007

Related U.S. Application Data
(60) Provisional application No. 60/854,797, filed on Oct. 27, 2006.

(51) Int. Cl. G06Q 40/00

(52) U.S. Cl. 705/35; 705/37

(57) ABSTRACT

The application of financial derivatives for hedging can often be very complex for an institution that feels they may need to incorporate them into their portfolio. We have designed a fundamental financial atom of constant risk (omega) for the purchaser and almost risk-free for the issuer and for constructing minimal changing hedges for the hedger as well as developed a method for determining the best combination of our atoms to obtain almost any hedge, and have shown how they can be applied and that combinations of financial atoms with different expiration dates can be combined.

### CROSS-REFERENCE TO RELATED APPLICATIONS

This application claims the benefit of PPA Appl. No. 60/854,797 filled on Oct. 27, 2006 by the present inventors. The Provisional Patent Application has the same title.

### FEDERALLY SPONSORED RESEARCH

Not applicable.

### SEQUENCE LISTING OR PROGRAM

Not applicable.

### BACKGROUND OF THE INVENTION

This invention pertains to processes and methods for the use in risk management hedging using derivatives. Specifically, it pertains to options which satisfy the Black and Scholes equation with short-term interest rate and volatility held as constant parameters or the case where interest rates and volatility depend on time or are stochastic as long as the solution to equation (1) (in the attached paper titled “Derivative Securities: The Atomic Structure” and listed as Attachment I.) also satisfies the separability condition (15). This includes stock options, foreign exchange options, commodity options, etc.

Options can be expensive to buy, risky to sell, expensive to rebalance, and usually need to be rebalanced often. What is new about our invention is that we define a small number of very simple derivative securities, called atoms, that are cheap to buy, almost risk-free to sell, cheap to rebalance, need only modest rebalancing, and a combination of a few of them can be used to approximate most any option.

### SUMMARY

Most of us view engineering as the building of things from smaller things. Furthermore, once the smaller things are in place, they are relatively invariant—there is no dynamic adjustment of the parts to maintain the whole. Nature, the master engineer, also appears to be quite satisfied with this scheme; there apparently is no need to continuously change the proportion of hydrogen and oxygen atoms in maintaining a water molecule. Yet, when we turn to “financial engineering”, the state of play changes dramatically. The building blocks are often combinations of small things and bigger, complex things and the proportion of the components varies substantially over the lifetime of the structure synthesized. For example, the hedging of stock options involves the dynamic rebalancing of cash, stock, and often more complex instruments with appropriate nonlinear behavior. In brief, financial engineering conveys only a limited sense of putting together fundamental stable parts into building a coherent whole.

We here introduce and apply for a patent for the definition of a set of simple derivative securities and a process that addresses the issues raised above. A set of fundamental derivative security building blocks is identified. These building blocks can then be combined to form a wide class of derivative structures and once in place the fundamental derivative security building blocks, which we call “financial atoms”, are quite stable and need only modest rebalancing.

The non-diversifiable risk of a stock with respect to an index is often measured by the quantity beta. Similarly, the beta of a derivative security with respect to its underlying instrument is termed the omega of the derivative. In a single factor world, this measure of risk is simply the elasticity of the derivative security which we will identify as a stock for the purposes of discussion. We determine a class of derivative securities with a constant omega and we define these securities as constant risk derivative securities. We determine n (for any n) derivative securities that satisfy both the Black and Scholes (BS) equation and the constant elasticity condition, which is equivalent to constant risk and is described in our detailed paper at the end of this specification.

These n derivative securities are very simple options, called atoms, that are cheap to buy, almost risk-free to sell, cheap to rebalance, need only modest rebalancing, and a combination of a few of them can be used to approximate most any option.

### What is Different:

We have designed a fundamental class of derivatives that are very simple to construct and which in a combination as specified by our approximation procedure can be used to estimate a wide class of payoff functions. These fundamental derivatives called financial atoms have constant risk and the combination used to approximate a wide class of payoff functions requires minimum rebalancing both to remain an accurate approximation of the Black and Scholes solution of the payoff throughout the life of the option and to remain an accurate approximation of the payoff in the case of volatility and risk-free changes.

### DETAILED DESCRIPTION

The detailed description of our invention including mathematics is given in the attached paper titled “Derivative Securities: The Atomic Structure”. Here we describe those details.

### The Design of the “Financial Atoms”:

We determine the financial atoms to be solutions of a simple equation that provides for constant risk (omega). The financial atoms are powers of an underlying instrument where the powers can be any real number. Certain collections of powers may be more suitable for use in different kinds of hedging instruments. The financial atoms are always defined on the interval [0,1] or, if desirable, an alternative interval [a,b] where a and b are any real numbers.

### Methods of Construction:

We use these financial atoms in a combination in order to approximate any payoff function that is continuous except on a set of measure zero. The combination and therefore the approximation is determined by a “best approximation” that gives the number of financial atoms determined for each atom in a collection. That number can be positive or negative and is determined by the minimization of a norm that we define in more detail in our paper that follows. A positive number of financial atoms means you buy the atoms and a negative number means you sell them.

The detailed methods of construction are described in a “cook-book” fashion in Attachment II.

### Methods of Application:

Institutions or entities can issue collections of financial atoms. Then any other institution or entity can determine the number of financial atoms for each atom in the collection in order to best approximate any desired payoff function. The number of financial atoms determined is then bought or sold. The determination of the number of financial atoms required for the approximation of the payoff function can be done by the issuing entity, the purchasing entity, or a third party using our procedure as described in the methods of construction and detailed in our attached papers (Attachments I and II) where we also detail the method of issuing atoms.

### Advantages of our Approach Include:

1. The financial atoms are of constant risk (omega);
2. The collection of financial atoms approximating the payoff requires minimal rebalancing to accurately approximate the Black and Scholes solution to the payoff function throughout the life of the option and therefore are cheaper than usual methods;
3. The collection of financial atoms requires minimal rebalancing (and therefore cheaper) to accurately approximate the Black and Scholes solution or variants thereof to the payoff function when the volatility and interest rate varies;
4. Our procedure is simple and applicable to a wide variety of derivatives used for hedging including multi-factor derivatives;
5. The financial atoms can be risk-free to reproduce since the atoms can be issued in positive and negative signs in equal amounts. This means they can be simultaneously bought and sold in equal amounts;
6. The financial atoms are cheap, easy to construct and market, and straightforward to understand; and
7. The financial atoms can be easily combined that have different expiration dates.

### ATTACHMENT I

Derivative Securities: The Atomic Structure¹
Jerome Kreuser²
Lester Seigel³
Oct. 21, 2006
¹This is a modified version of the paper published in the November/December 2006 issue of Financial Engineering News.
²Executive Director, The RisKontrol Group GmbH, kreuser@riskontroller.com. The RisKontrol Group GmbH in Bern, Switzerland http://RisKontroller.com.
³Senior Advisor to The Rock Creek Group, a $3 billion Hedge Fund of Funds and Senior Advisor to The RisKontrol Group, leseigel@aol.com.

### Abstract

In this paper, derivative security building blocks of constant risk (omega) are identified which satisfy the Black and Scholes equation and which, in aggregate, can be combined to form a wide class of derivative structures; once in place the fundamental options, which we term “financial atoms”, need only modest rebalancing. We introduce a user-friendly technology based on orthonormal polynomials to ascertain the appropriate combination of financial atoms needed to assemble more complex risk profiles.

### 1. INTRODUCTION

### The Engineering of Things

Most of us view engineering as the building of things from smaller things. Furthermore, once the smaller things are in place, they are relatively invariant—there is no dynamic adjustment of the parts to maintain the whole. Nature, the master engineer, also appears to be quite satisfied with this scheme; there apparently is no need to continuously change the proportion of hydrogen and oxygen atoms in maintaining a water molecule. Yet, when we turn to “Financial Engineering”, the state of play changes dramatically. The building blocks are often combinations of small things and bigger, complex things and the proportion of the components varies substantially over the lifetime of the structure synthesized. For example, the hedging of stock options involves the dynamic rebalancing of cash, stock, and often more complex instruments with appropriate nonlinear behavior. In brief, financial engineering conveys only a limited sense of putting together fundamental stable parts into building a coherent whole.

In this article, we introduce a simple mathematical scheme that addresses the issue raised above. A set of derivative security building blocks is identified. These building blocks can then be combined to form a wide class of derivative structures and once in place the fundamental options, which we call “financial atoms”, are quite stable and need only modest rebalancing.

### 2. CONSTANT RISK DERIVATIVES

The non-diversifiable risk of a stock with respect to an index is often measured by the quantity beta. Similarly, the beta of a derivative security with respect to its underlying instrument is termed the omega of the derivative. In a single factor world, this measure of risk is simply the elasticity of the derivative security which we will identify as a stock for the purposes of discussion. Let's ask ourselves if there is a class of derivative securities with a constant omega (constant risk derivative securities). We are searching for n derivative securities, Aₙ(S,t), that satisfy both the Black and Scholes (BS) equation and the constant elasticity condition:

$$\frac{S}{{A}_{n}} \frac{\partial {A}_{n}}{\partial S} = n \qquad ( 1 )$$

Where n is a real integer, Aₙ is the derivative security value, and S is the value of the associated stock. The solution to (1) and the BS equation, up to a constant multiple, is:

$${A}_{n} ( s , t ) = {e}^{- [ n ( n - 1 ) \frac{{σ}^{2}}{2} + ( n - 1 ) r ] t} {S}^{n} \qquad ( 2 )$$

Where σ and r are the volatility and risk-free rate. If we pick n=0,1,K,6 then: Aₙ(S,t)=e^{rt}, S, e^{-(σ}^{²}^{+r)t}S², e^{-(3σ}^{²}^{+2r)t}S³, e^{-(6σ}^{²}^{+3r)t}S⁴, e^{-(10σ}^{²}^{+44)t}S⁵, e^{-(15σ}^{²}^{+5r)t}S⁶.

The first two derivative securities are cash and stock. Thus what we might postulate as the full spectrum is the natural extension of cash and stock. Now we will see that it is possible to approximate many payoffs using combinations of these derivative securities.

### 3. A COMPLETE SET

The derivative securities (2) are solutions to the BS equation so that linear combinations of them are also solutions. We would like to take linear combinations to approximate as close as possible any payoff function at t=T such as, for example, max(S−K,0), the classical European Call. We define the set:

Π≡{S²|n=1,2,3,K are unique integers} (3)

Then, by a theorem of Weierstrass Π is closed in the class of continuous functions on [a,b] and by a theorem of Müntz we can relax the powers to non-integers and n is closed in L² (a,b). This means that functions in L² can be approximated arbitrarily closely by linear combinations of powers of S contained in Π and includes mild discontinuities such as exhibited by the Heaviside step function; i.e. a binary option payoff can be approximated arbitrarily closely. The non-integer powers can, theoretically, consist of an infinite collection of real numbers defined on a closed interval.

### 4. SPECTROSCOPIC DESIGN

Suppose our payoff function is f(S,t) for any time 0≦t≦T and for Sε[a,b]. We define a definition of closeness as:

$${‖ g ‖}_{ω}^{2} = {\int }_{a}^{b} {[ g ]}^{2} ω ( S ) d S \qquad ( 4 )$$

where ω is a weighting function with ω(S)≧0 ∀S ε[a,b] and

$${\int }_{a}^{b} ω ( S ) d S > 0.$$

Its purpose is to weight more heavily the points where it is more important to get the approximation more accurate. The interval [a,b] and the function ω are both important in selecting the appropriate number of derivative securities and we discuss this elsewhere. Define a collection of power series with:

$${P}_{m} ≡ {\sum }_{n = 0}^{m} {b}_{n} {S}^{n} \qquad ( 5 )$$

The following problem has a solution for some m chosen depending upon how good we want the approximation to be:

$$\begin{matrix}min \\ {b}_{0} , K , {b}_{m}\end{matrix} {‖ F ( S ) - {P}_{m} ( S ) ‖}_{ω}^{2} \qquad ( 6 )$$

where F(S) is the function we are approximating and this will be the payoff function we want to approximate with our financial atoms.
A solution to (6), which is called a “best approximation”, we denote as P*ₘ(S). This has a simple solution in the form of orthonormal Legendre polynomials, qₙ(S) as:

$${P}_{m}^{*} ( S ) = {\sum }_{n = 0}^{m} ( {\int }_{a}^{b} F ( S ) {q}_{n} ( S ) d S ) {q}_{n} ( S ) \qquad ( 7 )$$

Then the following function f(S,t) serves as the approximation to F(S) at t=T and is the Black and Scholes solution of the approximation throughout the life of the option:

$$f ( S , t ) = {\sum }_{n = 0}^{m} {a}_{n} {A}_{n} ( S , t ) = {\sum }_{n = 0}^{m} {a}_{n} {e}^{- [ n ( n - 1 ) \frac{{σ}^{2}}{2} + ( n - 1 ) r ] t} {S}^{n} \\ with {a}_{n} = {e}^{[ n ( n - 1 ) \frac{{σ}^{2}}{2} + ( n - 1 ) r ] T} {b}_{n} \qquad ( 8 )$$

We define the atom of degree n as an option that has a payoff of Sⁿ on [0,1]. We pick [a,b]=[0,1] for computational reason. It also provides simplicity in the definition and application of the atom. We will now illustrate the computational procedures with the European call.

### 4. ILLUSTRATION

Consider the case where F(S)=max(S−100,0); i.e. the European Call with a strike price of 100. The solution to (6) with m=6, [a,b]=[0,300], and ω≡1 gives:

$$\begin{matrix}{P}_{6}^{*} ( S ) = {b}_{0} + {b}_{1} ( \frac{S}{300} ) + {{b}_{2} ( \frac{S}{300} )}^{2} + {{b}_{3} ( \frac{S}{300} )}^{3} + {{b}_{4} ( \frac{S}{300} )}^{4} + \\ {{b}_{5} ( \frac{S}{300} )}^{5} + {{b}_{6} ( \frac{S}{300} )}^{6} \\ = - 5.21 + 263 ( \frac{S}{300} ) - 2880 {( \frac{S}{300} )}^{2} + 11061 {( \frac{S}{300} )}^{3} - \\ 17110 {( \frac{S}{300} )}^{4} + 12167 {( \frac{S}{300} )}^{5} - 3295 {( \frac{S}{300} )}^{6}\end{matrix} \qquad ( 9 )$$

where

$${( \frac{S}{300} )}^{n}$$

is an atom of degree n.
And then⁴: ⁴ Coefficients are rounded.

$$f ( S , t ) = - 5.21 {e}^{r ( T - t )} + 263 ( \frac{S}{300} ) - 2880 {{e}^{( {σ}^{2} + r ) ( T - t )} ( \frac{S}{300} )}^{2} + 11061 {{e}^{( 3 {σ}^{2} + 2 r ) ( T - t )} ( \frac{S}{300} )}^{3} - 17110 {{e}^{( 6 {σ}^{2} + 3 r ) ( T - t )} ( \frac{S}{300} )}^{4} + 12167 {{e}^{( 10 {σ}^{2} + 4 r ) ( T - t )} ( \frac{S}{300} )}^{5} - 3295 {{e}^{( 15 {σ}^{2} + 5 r ) ( T - t )} ( \frac{S}{300} )}^{6} \qquad ( 10 )$$

The approximation f(S,T) is graphed along with the European Call in the following figure where the approximation is taken on [0,300] and graphed on [0,200].
In the following we graph the Black-Scholes European Call and f(S,t) at t=T−0.5, or 6 months earlier. We use σ=0.3 and r=0.05

### 5. ISSUING FINANCIAL ATOMS AND THEIR APPLICATIONS

A financial atom is an option contract to pay an amount at a specified time in the future called the expiration date and which we have denoted by T. For example in the case of an atom of degree 3, an institution or entity may issue a contract to pay an amount equal to

$${( \frac{S}{300} )}^{3}$$

on Oct. 31, 2007, which depends on the value of the underlying instrument S. We note that we said the atoms were defined on the interval [0,1] (it could just as well be [a,b]). The approximation is done on that interval and does not work well outside of it. Therefore the value, 300 in this case, is chosen so that the range is sufficiently large so that it is unlikely that the value of S will fall outside of it. Therefore in order for the term in brackets to be always in the range [0,1] it is defined as:

$${( \frac{S}{300} )}^{′} = min ( 1 , max ( 0 , \frac{S}{300} ) ) \qquad ( 11 )$$

### From now on we assume this is the case so that the result is always in the interval [0,1]. Financial atoms would be issued in blocks of 100 or 1,000 or more.

During the life of the contract, the option has a value or price determined by the solution to the Black and Scholes equation. We denote that price by p(S,σ,r,t,T) where S,σ,r,t,T are defined as previously. In equation (10) we use f(S,t) for the price because we assume that σ,r,T do not change, however that may not be the case in general.

So, for example for an atom of degree 3 as defined in equation (10) we have:

$$p ( S , σ , r , t , T ) = {{e}^{( 3 {σ}^{2} + 2 r ) ( T - t )} ( \frac{S}{300} )}^{3} \qquad ( 12 )$$

When an entity issues an atom, it uses (12) to price it since it knows all the factors S,σ,r,t,T at that time. Now, suppose we had an atom of degree 3 with a different expiration date T′ with T″>T. Then its price at time t is given by p(S,σ,r′,t,T′) (σ has the same value) where r′ is the instantaneous risk-free rate of interest of an instrument maturing at time T′ and we have:

$$\begin{matrix}p ( S , σ , {r}^{′} , t , {T}^{′} ) = {{e}^{( 3 {σ}^{2} + 2 {r}^{′} ) ( {T}^{′} - t )} ( \frac{S}{300} )}^{3} \\ = {e}^{( 3 {σ}^{2} + 2 {r}^{′} ) ( {T}^{′} - T )} {{e}^{( 3 {σ}^{2} + 2 {r}^{′} ) ( T - t )} ( \frac{S}{300} )}^{3} .\end{matrix} \qquad ( 13 )$$

The first exponential term is independent of t and the second term is the expression for the financial atoms with an expiration date at T and a risk free rate of r′. But the correct number of financial atoms required for our approximation is given in equations (9) and (10) and is 11,061. Therefore the correct number of financial atoms with an expiration date of T′ is given by:

$$number of financial atoms required = \frac{11 \text{,} 061}{{e}^{( 3 {σ}^{2} + 2 {r}^{′} ) ( {T}^{′} - T )}} \qquad ( 14 )$$

There may be some confusion between number and price of contracts. The number of contracts refers to how many contracts are required for a specified time T. The price of the contract is how much a single contract costs at time t.

If σ,r,r′ are unchanged over time, then we will have the correct number of financial atoms at the expiration time t. But in the real world these are all functions of time and therefore some correction may be needed to maintain the approximation. When the changes over time in σ and r are known, then there exists methods of modifying the Black and Scholes equations to reflect this and those changes can be applied in our procedure here. Similarly modifications exist when σ and r are stochastic.

Here we assume that σ remains constant and that rebalancing is necessary to correct for changing r. Then the amount necessary given equation (13) is of the order of e^{2(r-r′)(T″-T)}. If the difference in maturity is three months and the difference in the interest rates amounts to 0.5%, then the rebalancing requires a change in the number of financial atoms of about 0.25%, or about 25 additional new atoms to be bought or sold. This is a very small adjustment and it requires no change in the financial atoms already in the portfolio. An analogous adjustment in σ over time will also result in a modest adjustment to the coefficients as in equation (14).

The fact that contracts of differing maturity can be used is due to the fact the price function is separable, that is it satisfies the separability condition that is written as:

p(S,σ,r,t,T)=g(σ,r,t,T)h(S) (15)

This is not the case, for example, in the Black and Scholes solution to the European Call.

The extension to the multi-factor world of derivatives (bond options, currency options, etc.) is simply the continuation of the technology described above with multi-factor polynomials. Atoms can be issued to approximate multi-factor derivatives by extending the polynomial approximation to polynomials of multiple factors. Suppose we have a derivative that we wish to approximate that is a function of two underlying instruments S₁ and S₂. Then our definition of closeness function (4) becomes:

$${‖ g ‖}_{ω}^{2} = {\int }_{a}^{b} {\int }_{c}^{d} {[ g ]}^{2} ω ( {S}_{1} , {S}_{2} ) d {S}_{1} d {S}_{2} \qquad ( 16 )$$

And our polynomial Pₘ of (5) becomes:

$${P}_{m , n} = {\sum }_{i = 0}^{m} {\sum }_{j \geq i}^{n} {b}_{i , j} {S}_{1}^{i} {S}_{2}^{j} \qquad ( 17 )$$

### The result is a collection of multi-factor atoms with the number in each case defined by b_{i,j}. The result extends in the natural way to derivatives of three or more factors.

### 6. CONCLUSIONS

In this article, elementary derivative functions (financial atoms) are identified that satisfy the Black and Scholes equation and which, in the aggregate, can be combined to form a wide class of derivative security risk profiles. If the market elected to trade even a handful of these financial atoms (which are universal for any single factor option), both speculators and hedgers could benefit. Speculators could carefully select their risk class with a derivative instrument bearing a constant elasticity relative to the underlying throughout the life of the contract. In turn the hedger could find a user-friendly technology to assemble combinations of the functions to form more complex derivative risk profiles; once in place, the synthesized structures require only limited rebalancing. In sum, the challenge to the market is simply this . . . issue these derivative financial atoms and provide building blocks of a true financial “engineering of things.”

### ATTACHMENT II

### Building a Stable Molecule

### Sep. 4, 2007

### Updated Oct. 4, 2007

### Summary

The process of building a stable molecule is one of selecting a set of atoms that makes for a stable combination that approximates well the boundary of the derivative. A set of atoms is stable if the approximation varies little with respect to small changes in the number of atoms and if it only takes a modest adjustment in the number of atoms to keep an accurate approximation of the derivative over time under changing conditions such as variations in the risk-free rate and volatility. This scheme makes rebalancing cheaper, less often, and easier. A stable molecule gives a static replication of the derivative in the sense of Derman et. al.

Atoms are cheap to produce and can be produced risk-free. This is done by simultaneously selling and buying the same amount of atoms. This process works because the sign of the collections of atoms tends to alternate from plus to minus. Approximations work almost as good when the signs are constrained to alternate from minus to plus. Thus there is as much a demand for buying as for selling atoms.

The molecular construction of atoms approximating derivatives allows for a wide range of properties to be built into the construction. For example, a stable molecule can be produced that approximates well the payoff of the derivative yet has a lower starting price or other interesting properties.

The molecular construction allows for molecules that approximate very large jumps as might be found in a Black Swan.

### Mathematical Description

We are concerned with derivatives defined on a set B with values f(S,t) for (S,t)εB. We assume that the values f satisfy the Black and Scholes equation; i.e.:

$$\frac{\partial f}{\partial t} + rS \frac{\partial f}{\partial S} + \frac{1}{2} {σ}^{2} {S}^{2} \frac{{\partial }^{2} f}{\partial {S}^{2}} = rf ∀ ( S , t ) ∈ B \qquad ( 1 )$$

with boundary values for f given as:

f(S,t)=f₀(S,t)∀(S,t)ε∂B (2)

### We assume that f₀, B, and ∂B (boundary of B) are suitably defined, that is, their definition is consistent with the theory for solutions of (1). For our cases, we assume B is bounded.

We define an atom of degree n, Aₙ, as:

$${A}_{n} ( S , t ) ≡ \{ \begin{matrix}{{e}^{{λ}_{n} ( T - t )} ( \frac{S}{K} )}^{n} & 0 \leq t \leq T , S \geq 0 , K > 0 ∀ ( S , t ) ∈ B \\ otherwise & 0\end{matrix} \qquad ( 3 )$$

And with:

$${λ}_{n} = ( n - 1 ) r + \frac{1}{2} n ( n - 1 ) {σ}^{2} \\ \begin{matrix}K \geq \begin{matrix}max \\ S\end{matrix} ( S , t ) ∈ B & 0 \leq t \leq T\end{matrix} \qquad ( 4 )$$

$$\frac{S}{K} ∈ [ 0 , 1 ]$$

The constant K is chosen so that ∀(S,t)εB and T is the terminal time with t=0 the time today. Since we can take f≡0 outside of B and this is also a solution to (1), this is a solution on open sets containing B.

### Theorem 1: With these definitions, an atom is a solution to (1) on B with f=Aₙ. Furthermore, Aₙ satisfies the constant elasticity condition,

$$\frac{\partial {A}_{n}}{\partial S} \frac{S}{{A}_{n}} = n .$$

### We define a molecule Mₙ as:

$${M}_{n} ( S , t ) = {\sum }_{i = 0}^{n} {a}_{i} {A}_{i} ( S , t ) \qquad ( 5 )$$

with (a₀, a₁, . . . , aₙ)=aε(−∞,+∞). When we want to designate Mₙ also as a function of a, we write it as Mₙ(S,t;a).

### Observations:

1. Aₙ is a solution to (1).
2. Mₙ is a solution to (1) for any a₀, a₁, . . . , aₙ.
3. For typical values, say n=6, r=0.05, σ=0.15, 0≦t≦T, we have 0≦Aₙ≦1.8.

### Suppose we know f₀, B, and ∂B, where ∂B may be some partial boundary of the whole set B. Then what can we say about solutions to (1) and (2).

Theorem 2: Under certain conditions on f₀, B, and ∂B then:
1. There exists a solution, f(S,t) to (1) and (2).
2. The solution is unique.
3. The solution is stable: A small change in the boundary values induces only a small change in the solution, f.

### Theorem 3: Assume that f₀ is piecewise continuous on the ∂B. Then given any ε>0, we can find an n∥f₀(S,t)−Mₙ(S,t)∥≦ε ∀(S,t)ε∂B.

### This is a consequence of the approximating polynomial.

### Theorem 4: Assume that f₀, B, and ∂B satisfy the conditions of Theorem 2. Then given any ε>0, we can find an n∥f(S,t)−Mₙ(S,t)∥≦ε ∀(S,t)εB.

### This is a consequence of Theorem 2 and Theorem 3. However, the ε need not be the same in Theorem 3 as in Theorem 4.

### Stable Molecule

We say that Mₙ is a stable molecule if the following two conditions hold:
1. A small percentage perturbation in the coefficients aᵢ produces only a small percentage perturbation in the molecule Mₙ.
2. A small percentage perturbation in the molecule Mₙ induces a small percentage change in the coefficients aᵢ.

We will formalize these conditions later. We note that they are also dependent on the stability of solutions to (1) as outlined in Theorem 2. The first condition depends on the continuity of Mₙ in aᵢ. But Mₙ is linear in aᵢ and since Aₙ is close to one by the choice of K, this depends directly on the size of the aᵢ relative to the size of Mₙ. The second condition is the reverse of the first. It says that if Mₙ changes, then a comparatively modest change is induced in the aᵢ. This means, for example, a small perturbation in the risk-free rate and the volatility requires only a modest change in the aᵢ to accurately approximate the modified solution to (1).

An example easily illustrates this in two dimensions. In 2-dimensional space these conditions are equivalent to a slope of Mₙ that is neither too big nor too small. A slope of 1 gives a stable molecule. A slope of 10⁶ or 10⁻⁶ does not. A slope of 10⁶ will give a major change in Mₙ for a small change in aᵢ. Therefore if we miss by an atom or two, the approximation can be way off. On the other hand, for 10⁻⁶, if Mₙ changes by a small amount, then the aᵢ would need to change substantially. This is also not desirable since we would like small changes to the risk-free rate and the volatility to induce small changes in the number of atoms required to match the change.

Because of theorems 1 through 4, our goal is to approximate f₀ on ∂B as best as possible with Mₙ. Since Mₙ solves (1) and the solution f is unique, we have an approximation that can be used in place of f.

### The Approximation Problem

Therefore the approximation problem that we wish to solve can be written as:

$$\begin{matrix}MIN \\ ( {a}_{0} , {a}_{1} , … {a}_{n} ) ∈ C\end{matrix} ‖ {f}_{0} - {M}_{n} ‖ \qquad ( 6 )$$

where the norm is computed for (S,t)ε∂B.

Different problems are formulated based upon the selection of the choice of the norm, ∥ ∥, and upon the set C. We now discuss some of the possibilities that we have used for these by a discussion of the formulation of three norms of interest.

### The 1-norm: The 1-norm is defined with the following line integral

∥f₀−Mₙ∥₁=∫_{7B}|f₀(S,t)−Mₙ(S,t)|ω(z)dz (7)

where ω(z) is a weighting function with ω(z)≧0 and ∫_{∂B}ω(z)dz>0. The integration over the boundary ∂B is done on the sectionally smooth curve defined by:

S=S(z)

t=t(z) (8)

Using (8), the line integral in (7) is defined precisely as:

$${\int }_{\partial B}^{ } \vert {f}_{0} ( S , t ) - {M}_{n} ( S , t ) \vert ω ( z ) d z = {\int }_{α}^{β} ( \vert ( {f}_{0} ( S ( z ) , t ( z ) ) - {M}_{n} ( S ( z ) , t ( z ) ) ) \frac{\partial S}{\partial z} \vert ) ω ( z ) d z + {\int }_{α}^{β} ( \vert ( {f}_{0} ( S ( z ) , t ( z ) ) - {M}_{n} ( S ( z ) , t ( z ) ) ) \frac{\partial t}{\partial z} \vert ) ω ( z ) d z \qquad ( 9 )$$

where the integration is defined for zε[α,β] which maps out the curve in (8). Generally, we define this curve as a square but it can take any shape.
For example, for (8) we might use [α,β]=[0,4]. Then for each side of the square we could define the following:

$$( 1 ) z ∈ [ 0 , 1 ] and S ∈ [ 50 , 200 ] so S = 150 z + 50 and \\ \frac{\partial S}{\partial z} = 150 and \frac{\partial t}{\partial z} = 0 \\ ( 2 ) z ∈ [ 1 , 2 ] and T - t ∈ [ 0 , 1 ] so t = T - z + 1 and \\ \frac{\partial t}{\partial z} = - 1 and \frac{\partial S}{\partial z} = 0 \\ ( 3 ) z ∈ [ 2 , 3 ] and S ∈ [ 200 , 50 ] so S = - 150 z + 500 and \\ \frac{\partial S}{\partial z} = - 150 and \frac{\partial t}{\partial z} = 0 \\ ( 4 ) z ∈ [ 3 , 4 ] and T - t ∈ [ 1 , 0 ] so t = T + z - 4 and \\ \frac{\partial t}{\partial z} = 1 and \frac{\partial S}{\partial z} = 0 \qquad ( 10 )$$

In order to solve the general problem computationally, we write the integral as an approximating sum. For the 1-norm, then we can solve the problem as a linear programming problem. The formulation for the norm then is:

$${\int }_{\partial B}^{ } \vert {f}_{0} ( S , t ) - {M}_{n} ( S , t ) \vert ω ( z ) d z \approx {\sum }_{i} \vert ( {f}_{0} ( S ( {z}_{i} ) , t ( {z}_{i} ) ) - {M}_{n} ( S ( {z}_{i} ) , t ( {z}_{i} ) ) ) p ( {z}_{i} ) \vert ω ( {z}_{i} ) \qquad ( 11 )$$

where the sum is taken over the N points zᵢε[α,β] and

$$= \frac{β - α}{N}$$

and where p(zᵢ) takes the value of the partial derivative depending on which side of the square we are on for zᵢ; i.e.

$$p ( {z}_{i} ) = \vert \frac{\partial S}{\partial z} \vert or p ( {z}_{i} ) = \vert \frac{\partial t}{\partial z} \vert$$

while the other partial derivative is zero since the curve is a square here.
Now let:

dᵢ(a)=(f₀(S(zᵢ),t(zᵢ))−Mₙ(S(zᵢ),t(zᵢ));a) (12)

We note that dᵢ(a) is a linear function in a measuring the deviation in the approximation. Then the approximation problem (6) becomes, for our 1-norm problem, the following linear programming problem:

$$\begin{matrix}MIN \\ {dev}_{i} , a\end{matrix} {\sum }_{i} {dev}_{i} \\ subject to \\ ( {a}_{0} , {a}_{1} , … {a}_{n} ) ∈ C \\ {dev}_{i} \geq {d}_{i} ( a ) ω ( {z}_{i} ) p ( {z}_{i} ) \\ - {dev}_{i} \leq {d}_{i} ( a ) ω ( {z}_{i} ) p ( {z}_{i} ) \qquad ( 13 )$$

### We note that the term p(zᵢ) becomes the partition of each side of the square into the appropriate interval size for that side.

The 2-norm: The square of the 2-norm is defined as:

∥f₀−Mₙ∥₂²=∫_{∂B}(f₀(S,t)−Mₙ(S,t))²ω(z)dz (14)

Here the approximation problem (6) becomes the following quadratic programming problem:

$$\begin{matrix}MIN \\ a\end{matrix} {\sum }_{i} {( {d}_{i} ( a ) )}^{2} ω ( {z}_{i} ) p ( {z}_{i} ) \\ subject to \\ ( {a}_{0} , {a}_{1} , … {a}_{n} ) ∈ C \qquad ( 15 )$$

The infinity norm: The infinity norm or what is called the “maximum norm” in classical numerical analysis books is defined as:

$${‖ {f}_{0} - {M}_{n} ‖}_{∞} = \begin{matrix}MAX \\ ( S , t ) ∈ \partial B\end{matrix} \vert {f}_{0} ( S , t ) - {M}_{n} ( S , t ) \vert ω ( z ) \qquad ( 16 )$$

Then the approximation problem (6) becomes, for our ∞-norm problem, the following linear programming problem:

$$\begin{matrix}MIN \\ dev , a\end{matrix} dev \\ subject to \\ ( {a}_{0} , {a}_{1} , … {a}_{n } ) ∈ C \\ dev \geq {d}_{i} ( a ) ω ( {z}_{i} ) \\ - dev \leq {d}_{i} ( a ) ω ( {z}_{i} ) \qquad ( 17 )$$

### The Recipes and the Options

In the course of our mathematical discussion it should have become clear that there are a significant number of options that may be decided in obtaining an approximating molecule to our derivative function. These options are important and are used to tailor a molecule to have the properties most suitable for the buyer.

By now it may be clear that the variety of the atoms available is a good thing and that the atoms that have been created of varying maturities T, and on differing sets B, or with differing constants K can all be combined together to create a molecule simply by including them in the sum in equation (5). Then in solving (6) the best combination to produce the most accurate approximation is automatically selected.

Similarly, a molecule can be created with different properties by varying the maximum degree n in equation (5) that is considered or the combination of atoms considered, changing the constraint set C, changing the definition of the boundary, selecting the norm to do the approximation, changing the weight function ω(z), modifying the curve given in (8), and changing the number of points in the discretization of the integral. We now discuss the different ways of creating atoms and molecules.

### Creating Varieties of Atoms:

Atoms can be created with different properties. The list of possibilities includes:
1. Changing the maturity T: The maturity of an atom can be set by the issuer and atoms of different maturities can easily be combined to make a molecule.
2. Modifying the set B: An atom can be defined on a set B that is most desirable to the issuer and the user. Atoms defined on different sets B can be combined to make a molecule.
3. Modifying the constant K: The constant K is chosen so that on the range of definition of the atom on S that the value

$$\frac{S}{K} \leq 1.$$

This is done for computational reasons. When n is very large, say greater than 15, then K should be chosen a little larger to avoid computational problems when S is close to K.

### Creating Molecules with Specified Properties:

There are many options to consider when creating a molecule. The list includes:
1. Picking the maximum degree, n, or the combination of atoms: Picking a larger n is guaranteed to increase the accuracy of the approximation. However, in empirical work to date an approximation around n=6 is quite satisfactory for vanilla options. Another technique is to change the collection of atoms used with different properties but a not too large n. For example, combining atoms of different maturities or defined on different sets.
2. Changing the constraint set C: A big factor in computing a stable molecule is controlling the size of the variables aᵢ. This can be handled by including in the constraint set C constraints of the following form: −100≦aᵢ≦100. There is a tendency in the minimization process as defined in (6) to have the aᵢ get very large in absolute value. This can be controlled by including the above constraint. The constraint need not be symmetrical. Constraints of this type often do not cause a great deviation from the optimal approximation and so are very suitable. Constraints can be defined so that the molecule Mₙ passes through a particular point. For example, the point (S₀,t₀) that has a lower price or at some point on the boundary where it is most important. Constraints may be used to control the kinds of atoms that are used to build a molecule. For example, suppose only puts are available for atoms of degree 3. The appropriate constraint to use when constructing the molecule would then be a₃≦0. Numerous other examples can be constructed.
3. Changing the definition of the boundary, ∂B: The definition of the boundary may be changed depending upon the properties to be imparted to the molecule. Consider the up-and-out call as defined in the Derman paper. The boundary in that paper is along the curve S=0,120; T-t=0,1; S=120,90; and T-t=1,0. we could just as well have run the boundary from S=40,120 if there is a bigger probability that S will take smaller values. Or consider the European call. We could run the boundary only on the S-axis from S=0 to almost S=∞. Or we could run it from say S=50,200 only on the S-axis. Or on the square depending on the properties desired. If we run on the boundary only along S=50,200, then we have more freedom to obtain a molecule with a lower starting price than the European call yet have a similar payoff. Or other properties can be induced.
4. Selecting the norm to use: Any of the three norms mentioned above may be selected or other norms may be chosen. The one and infinity norms tend to produce values aᵢ that are a little smaller (more stable molecule) than in the 2-norm but the 2-norm tends to give a better looking graph of the payoff profile at time t=T. And the one and infinity norm are both linear so if the number of combinations is very large this problem may be more tractable. But the problems in our experience so far have not caused any computational difficulty.
5. Changing the weight function ω(z): In all case we have tested so far we have used ω≡1. Different functions ω(z) would be used when the user wants a better approximation along one part of the boundary or another.
6. Modifying the curve given in (8): This can be done although it seems to make little difference to the approximation result.
7. Changing the number of points in the discretization of the integral: Here we have used 100 points along any side of the curve and this seems to be very satisfactory. More points can be used for more complicated derivatives.

### The Recommended Recipe

The following general recommendations are given pending more empirical work or specialized properties that need to be imparted to an atom or molecule.

### When Creating an Atom:

1. Create atoms with whatever maturity T is desirable by the issuer.
2. Use whatever set B is desirable by the issuer.
3. Pick K so that it equals the maximum value of S.

### When Creating a Molecule:

The creation of the molecule should be done to satisfy the required properties. In general the following can be used:
1. Pick the maximum n to be 6 but add as many atoms as are available into the definition of the molecule in equation (5).
2. Use bounds −100≦aᵢ≦100 but adjust these while visualizing the payoff at maturity of the molecule to ensure that it gives a good approximation. Add whatever additional constraints are necessary to obtain the desired properties.
3. Pick the boundary to be not too big but to give a reasonable size to include most possible paths of the variable S.
4. Pick the 1-norm as a starting approximation and test to see if it gives a stable molecule.
5. Use the weight function ω≡1 unless otherwise specified by the user.
6. Use a linear expression for the curve in (8).
7. Use 100 points along each side of the boundary and then recheck results with 1,000 points.

Having described our invention, what we claim as new and desire to secure by patent is given in the following claims:

1. Independent: We claimed to have defined a collection of very simple derivatives of constant risk whereby a small number of the collection in various amounts may be used to approximate most any option.

2. Independent: We claimed to have defined a methodology for approximating most any option by a collection of very simple derivatives of constant risk. Said methodology consists of:
a. Constructing a collection of very simple derivatives of constant risk as defined in Attachment I.
b. Defining the amount of each simple derivative in the collection by approximation by minimizing a specified norm with constraints.
c. Adding constraints and limitations to the approximation specified in b. so that they are stable in the usual sense of differential equations.

3. Independent: We claimed to have defined a method for issuing and applying the said collection of atoms of constant risk by selling and buying said atoms in equal amounts whereby their sale and purchase will be much cheaper than the option they are approximating.

4. Dependent on claim 1: We have developed the definition of the financial atoms themselves, which are based on an underlying asset raised to a power that may be any real number, and are transformed to the interval [0,1] and then rescaled by the number of financial atoms required in order to approximate a desired payoff function.

5. Dependent on claim 2: We have developed a method of approximation of the payoff using combinations of a specified number of financial atoms that consists of a “best approximation” characterized by minimizing the norm of the difference between the number of the combination of financial atoms and the payoff function where we allow any norm to be used as is defined more precisely in our attached paper II.

6. Dependent on claim 3: We have developed a method for the sale of the collection of financial atoms approximating the payoff function to be undertaken by any institution or entity and consists of the sale of individual financial atoms or multiples thereof, which in a combination determined by our method of approximation, can be used to approximate any desired payoff function arbitrarily closely and when bought in sold in equal amounts make the resulting costs very cheap and risk-free.

7. Dependent on claim 1: We claim that a proper combination of our financial atoms as determined by our approximation method need only minor rebalancing to properly approximate the Black and Scholes equation of the payoff function as it changes over time or to re-approximate the Black and Scholes equation to account for changes in volatility or interest rates.

8. Dependent on claim 2: We have developed a method for determining a collection of financial atoms for multi-factor derivatives using a simple modification of the method of approximation to that of polynomials of several variables which results in the sums of products of individual financial atoms and is used to estimate the payoff function depending upon two or more factors and discussed in detail in our attached paper.

9. Dependent on claim 2: We have developed a method for determining a collection of financial atoms that can easily be combined that have different expiration dates and that provide a close approximation to any payoff function throughout the life of the option.

10. Dependent on claim 1: We have developed a method for determining a collection of financial atoms that can be defined for a variant of the Black and Scholes equation to, for example, satisfy conditions where the volatility and interest rate change over time or are stochastic as long as the financial atoms satisfy the variant to the Black and Scholes equation, that they satisfy the constant risk (omega) condition (1) defined in our attached paper, and that they satisfy the separability condition (15) defined in our attached paper.

11. Dependent on claim 2: we have developed a method of determining a specified number of simple derivatives of constant risk from a small collection of derivatives to approximate most any option whereby a small change in the number of derivatives produces only a small change in the approximated option and a small change in the volatility and the risk-free rate of the option requires only a small change in the number of simple derivatives approximating the option Kreuser and Seigel Oct. 21, 2007
